(19) United States
(12) Patent Application Publication
(10) Pub. No.: US 2017/0341494 A1
(43) Pub. Date: Nov. 30, 2017

(54) AUTOMATED SOFT TONNEAU COVER

(71) Applicant: BOS Automotive Products, Inc., Rochester Hills, MI (US)

(72) Inventors: Mickey Alan Hannan, Shelby Township, MI (US); Jürgen Josef Salewski, Rochester Hill, MI (US); Edwin Joseph Steinmetz, Lapeer, MI (US); Michael David Uhazie, Oakland Twp., MI (US); Michael Alan Kage, Warren, MI (US)

(21) Appl. No.: 15/602,961

(22) Filed: May 23, 2017

Related U.S. Application Data
(60) Provisional application No. 62/341,166, filed on May 25, 2016.

(51) Int. Cl. B60J 7/08; B65H 75/42; B62D 33/04

(52) U.S. Cl. CPC B60J 7/085; B65H 75/425; B62D 33/04

(57) ABSTRACT

A retractable cover system includes a pre-assembled drive system including a main roller about which a flexible cover is wrapped. Bows support the flexible cover in an extended position. The bows include a last bow. A drive motor is operatively coupled to the main roller and is configured to move the flexible cover between the extended position and a retracted position. A pre-assembled guide rail includes a cable system that has a driven gear operatively coupled to a drum. A cable is wrapped about the drum and at least one idler. The last bow is unsecured to the cable of the pre-assembled guide rail. A joint is configured to interconnect the pre-assembled guide rail to the pre-assembled drive system in an assembled condition to provide an assembled retractable cover system. The joint permits the drive gear and the driven gear to engage one another in the assembled condition. The last bow is secured to the cable in the assembled condition.

### CROSS-REFERENCE TO RELATED APPLICATIONS

This application claims priority to U.S. Provisional Application No. 62/341,166, which was filed on May 25, 2016 and is incorporated herein by reference.

### BACKGROUND

This disclosure relates to cover system used, for example, as a tonneau cover of a pickup truck bed that is configured for easy transport and assembly. The cover system may also be used, for example, as a flexible roof or sunshade for vehicle applications, or for non-vehicle applications as well.

Tonneau covers are frequently used to enclose a pickup truck bed. Soft tonneau covers provide the advantage over hard covers of being able to be stowed in a relative small space when the cover is not in use. There has been an effort to provide a motorized tonneau cover, but these tonneau covers lack the advantages of soft tonneau covers, namely, their compactness when stowed. For example, typical motorized tonneau covers resemble a roll up garage door, which incorporate numerous rigid slats pivotally linked to one another. These arrangements are heavy and bulky, occupying a significant portion of the truck bed. What is needed is a motorized soft tonneau cover that is compact, weather resistant and sufficiently robust to withstand common load conditions.

### SUMMARY

In one exemplary embodiment, a retractable cover system includes a pre-assembled drive system including a main roller about which a flexible cover is wrapped. Bows support the flexible cover in an extended position. The bows include a last bow. A drive motor is operatively coupled to the main roller and is configured to move the flexible cover between the extended position and a retracted position. A pre-assembled guide rail includes a cable system that has a driven gear operatively coupled to a drum. A cable is wrapped about the drum and at least one idler. The last bow is unsecured to the cable of the pre-assembled guide rail. A joint is configured to interconnect the pre-assembled guide rail to the pre-assembled drive system in an assembled condition to provide an assembled retractable cover system. The joint permits the drive gear and the driven gear to engage one another in the assembled condition. The last bow is secured to the cable in the assembled condition.

In a further embodiment of any of the above, the joint is a pivot joint that connects the pre-assembled guide rail to the pre-assembled drive system.

In a further embodiment of any of the above, the joint is a first joint and the guide rail is a first guide rail. A second joint supports a second guide rail to the pre-assembled drive system on an opposite lateral side than the first guide rail. The first and second joints are offset from one another to permit the first and second guide rails to fold inward toward and parallel to one another in a shipping condition.

In a further embodiment of any of the above, the joint is a provided by at least one of a detachable tongue and groove arrangement or a lap joint arrangement that permits the pre-assembled guide rail to be fully decoupled from the pre-assembled drive system in a shipping condition.

In a further embodiment of any of the above, the drum and the driven gear are coaxial with and rotationally fixed relative to one another.

In another exemplary embodiment, a method of assembling a retractable cover system includes the steps of providing a pre-assembled guide rail with a cable system. A pre-assembled drive system is provided that includes a flexible cover wrapped about a main roller operatively coupled to a motor The pre-assembled drive system is connected to the pre-assembled guide rail and operatively couples the motor to the cable system.

In a further embodiment of any of the above, the cable system includes a cable wrapped about a drum and at least on idler, the connecting step includes operatively coupling the motor to the drum.

In a further embodiment of any of the above, the pre-assembled guide rail includes a driven gear operatively coupled to the drum. The pre-assembled drive system includes a drive gear operatively coupled to the motor. The connecting step includes moving the drive gear and the driven gear into meshing engagement with one another.

In a further embodiment of any of the above, the drum and the driven gear are coaxial with and rotationally fixed relative to one another.

In a further embodiment of any of the above, the connecting step includes unfolding the pre-assembled guide rail relative to the pre-assembled drive system about a pivot joint.

In a further embodiment of any of the above, the connecting step includes securing an end of the pre-assembled guide rail to the pre-assembled drive system.

In a further embodiment of any of the above, the pre-assembled drive system includes bows supporting the flexible cover and including a last bow. The connecting step includes securing the last bow to the cable.

In another exemplary embodiment, a retractable cover system includes a drive system that has a flexible cover wrapped about a main roller. A motor is operatively coupled to the main roller and is configured to move the flexible cover between an extended position and a retracted position. A crank is configured to selectively and operatively cooperate with the main roller to manually move the flexible cover between an extended position and a retracted position without power from the motor.

In a further embodiment of any of the above, a first bevel gear operatively coupled to the main roller. A second bevel gear is configured to selectively mesh with the first bevel gear in response to a crank.

In a further embodiment of any of the above, a spring biasing the second bevel gear to a normally unmeshed position with respect to the first bevel gear.

In a further embodiment of any of the above, the second bevel gear is supported by a tube. The crank is configured to be inserted into the tube to rotationally fix the crank relative to the tube. The tube is configured to move the second bevel gear into engagement with the first bevel gear in response to axial movement of the crank.

In a further embodiment of any of the above, an access cover removably secured to the drive system covers the tube.

In a further embodiment of any of the above, a guide rail has a cable system with a cable wrapped about a drum and at least one idler. The drum operatively coupled to the motor. The drive system includes bows configured to support the flexible cover when in the extended position.

In another exemplary embodiment, a method of manually operating a retractable cover system includes the steps of inserting a crank into a drive system that has a flexible cover wrapped about a main roller. The main roller is rotationally driven with the crank. A flexible cover is moved along guide rails between an extended position and a retracted position in response to the rotationally driving step.

In a further embodiment of any of the above, the inserting step includes moving first and second bevel gears into engagement with one another.

In a further embodiment of any of the above, the inserting step includes depressing a spring that biases the first and second bevel gears apart from one another.

In a further embodiment of any of the above, the rotationally driving step includes rotationally driving the second bevel gear with the first bevel gear.

In a further embodiment of any of the above, the method includes the step of decoupling a clutch that interconnects a motor to the main roller.

### BRIEF DESCRIPTION OF THE DRAWINGS

The disclosure can be further understood by reference to the following detailed description when considered in connection with the accompanying drawings wherein:

FIG. 1 schematically illustrates a pickup truck with an example cover system embodiment with a flexible cover in a partially open position with respect to a truck bed.

FIG. 1A is a perspective view of side rails assembled to a drive system.

FIG. 1B is an exploded view of pre-assembled side rails prior to assembly with a pre-assembled drive system.

FIG. 1C is an exploded perspective view of the pre-assembled side rails packaged with the pre-assembled drive system for shipping.

FIG. 2A is an enlarged exploded perspective view of an end of the pre-assembled guide rail prior to mating with the pre-assembled drive system.

FIG. 2B is an exploded perspective view similar to that shown in FIG. 2A but with the drive components associated with the pre-assembled drive system removed.

FIG. 2C is an exploded perspective view similar to 2B but with the end removed and including an example joint for connecting the pre-assembled guide rail to the pre-assembled drive system.

FIG. 3A is an enlarged perspective view similar to that of FIG. 2B but with the end of the side rail secured to the drive system.

FIG. 3B is perspective view similar to FIG. 3A but with the end removed.

FIG. 4 is an exploded top perspective view of an end of the pre-assembled guide rail prior to assembly to the pre-assembled drive system, also illustrating bow end first and second portions prior to assembly.

FIG. 5 is an exploded top perspective view similar to FIG. 4 with the bow end first and second portions secured to the one another prior to assembly of the pre-assembled guide rail to the pre-assembled drive system.

FIG. 6A is a perspective view of a gear system and cable system.

FIG. 6B is a side view of the gear system and cable system shown in FIG. 6A.

FIG. 7A similar to the perspective view shown in FIG. 1A but with a manual drive crank installed.

FIG. 7B is a perspective view of the cover system shown in FIG. 7A illustrating a portion of the cable system and the gear system.

FIG. 8 is a rear perspective view of the manual override system with a set of beveled gears uncoupled from one another.

FIG. 9 is a rear perspective view similar to that of FIG. 8 but with the set of beveled gears engaged with one another for manually operating the flexible cover with the crank.

FIG. 10 is another example cover system with foldable guide rails for shipping.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

This disclosure relates to a motorized, flexible cover system for use in a variety of applications. In one example, the cover system may be used as a tonneau cover to selectively provide access to a vehicle truck bed. The cover system may also be used as a flexible roof or sunshade for vehicle applications, or for non-vehicle applications as well.

Furthermore, this disclosure incorporates by reference in their entirety U.S. application Ser. Nos. 15/042,358; 15/042,374 and 15/042,383, all entitled “AUTOMATED SOFT TONNEAU COVER,” and all filed on Feb. 12, 2016.

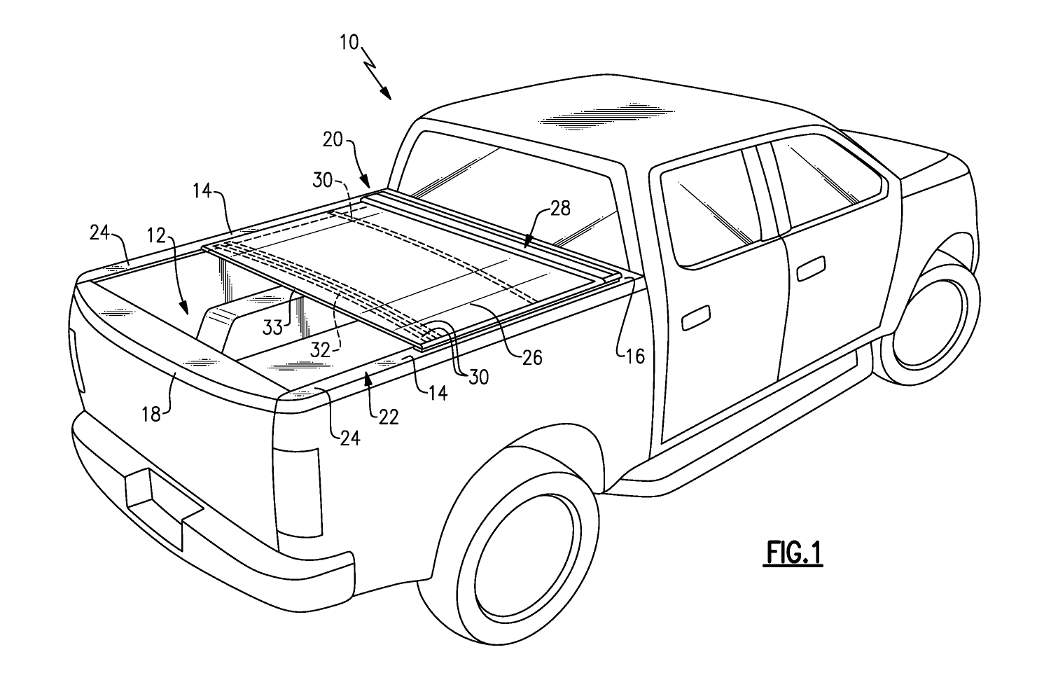

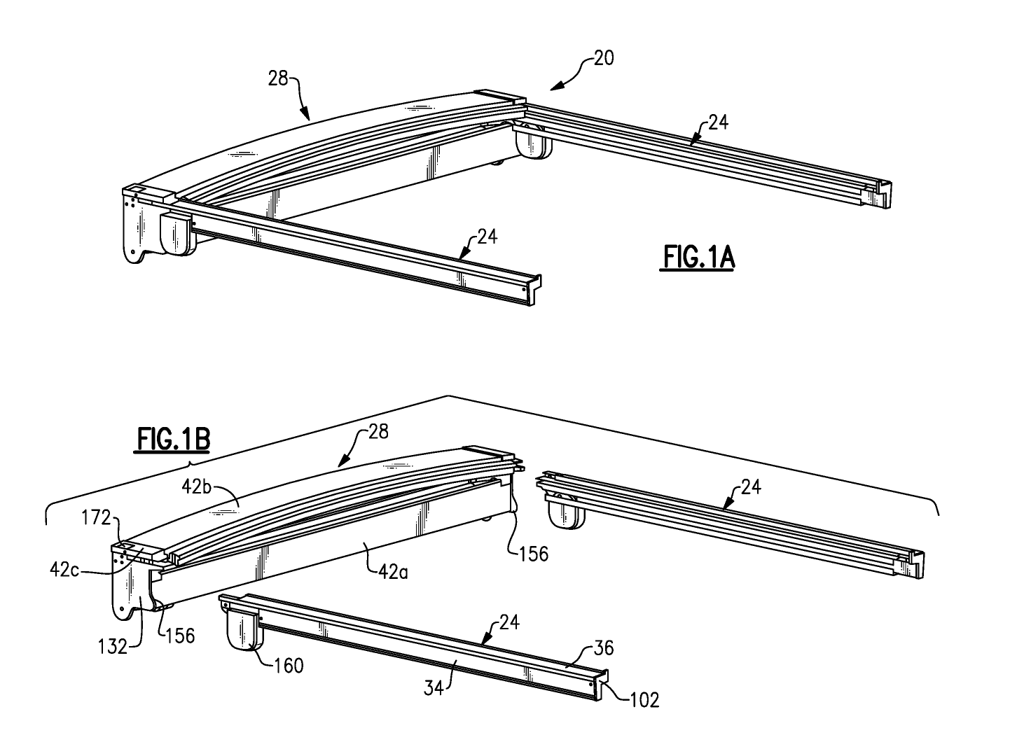

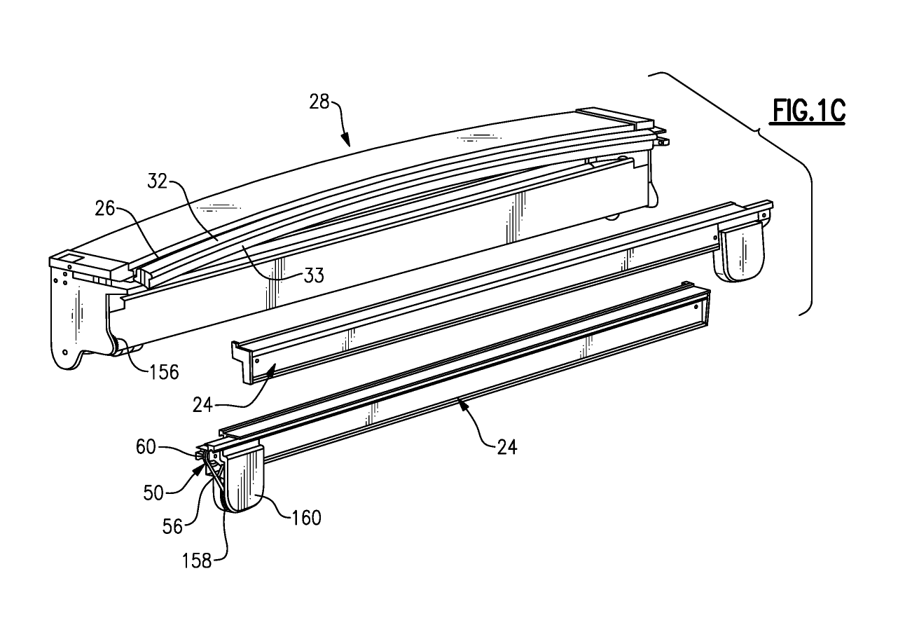

A vehicle 10 is schematically illustrated in FIG. 1. The vehicle 10 includes a truck bed 12 having lateral sides 14 and a front wall 16. A gate 18 is typically pivotally attached to a rear of the truck bed 12. A cover system 20 is mounted to the top of the truck bed 12 and is moveable between open and closed positions, including in a partially open position, as illustrated. If desired, the cover system 20 can be moved between an infinite number of positions.

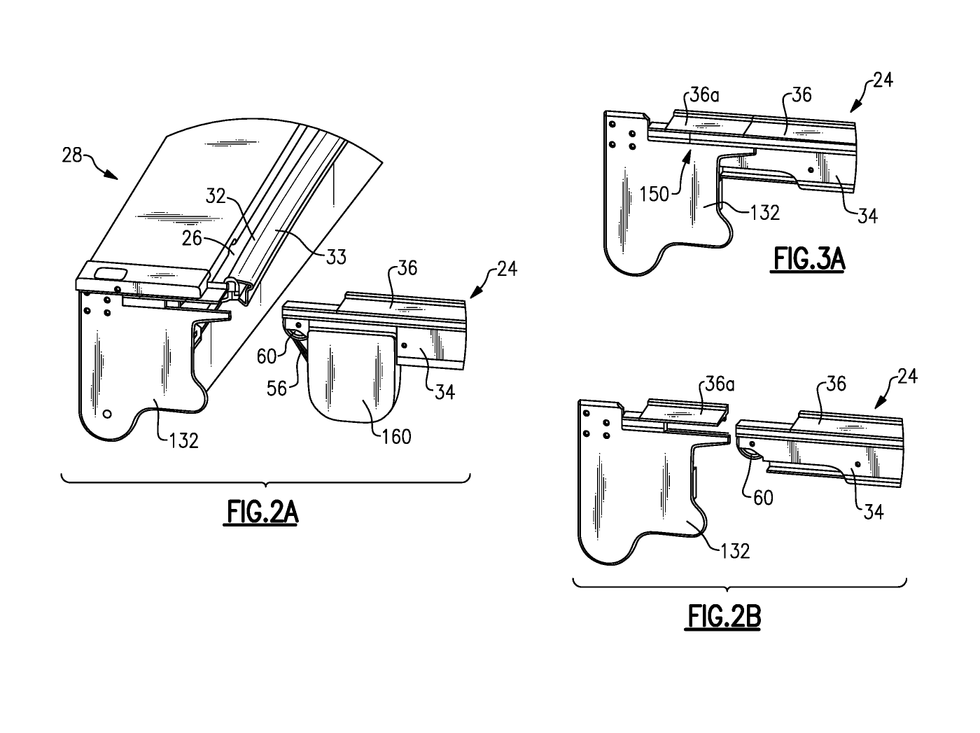

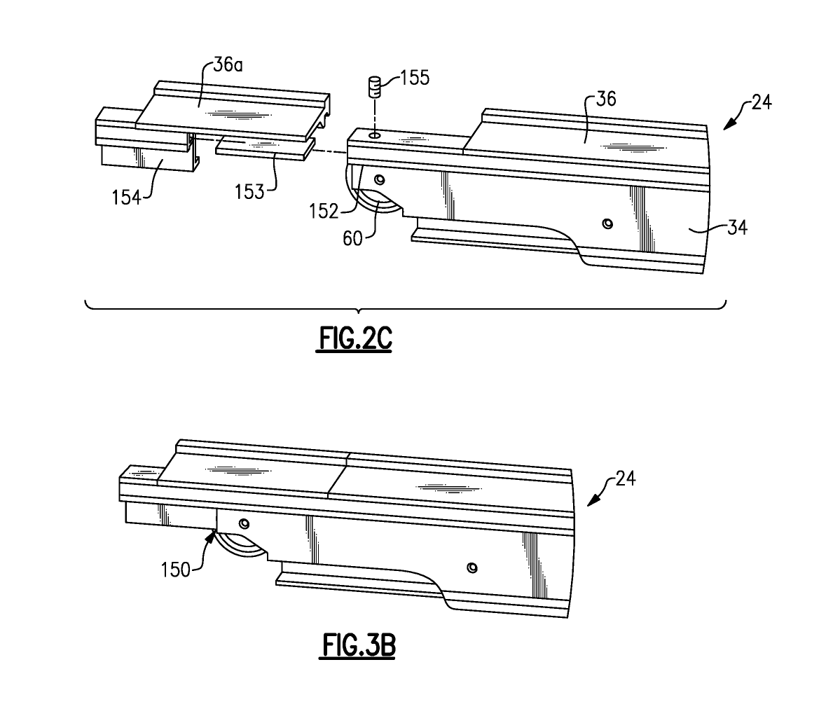

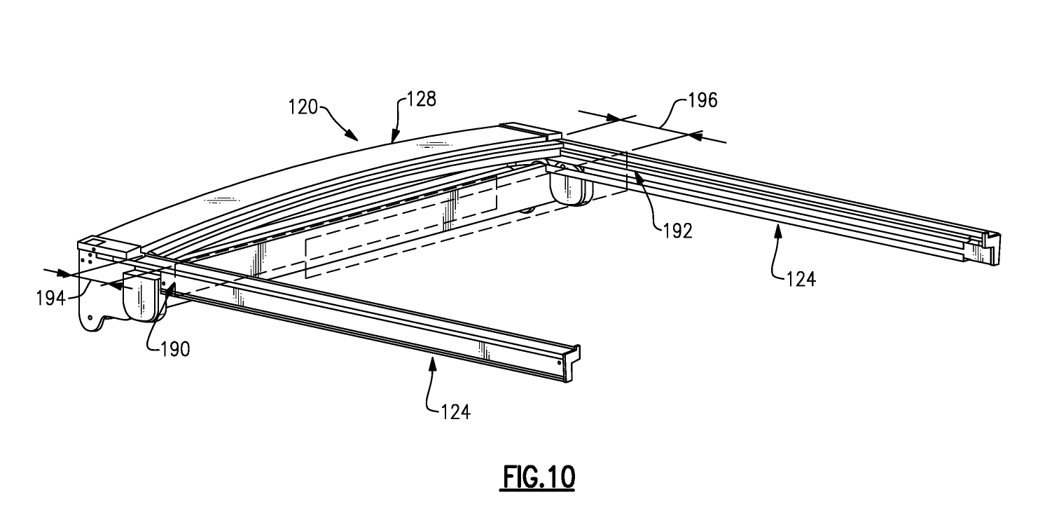

The cover system 20 includes three main assemblies: first and second guide rails 24 and a drive system 28. Each of these assemblies are provided to the installer (OEM or aftermarket) as pre-assembled units that can be compactly packaged with one another (e.g., FIGS. 1C and 10) for transport and then reconfigured during installation of the cover system 20 onto the vehicle 10. During installation, the drive elements of the cover system 20 can be easily coupled to one another (FIGS. 2A-6B).

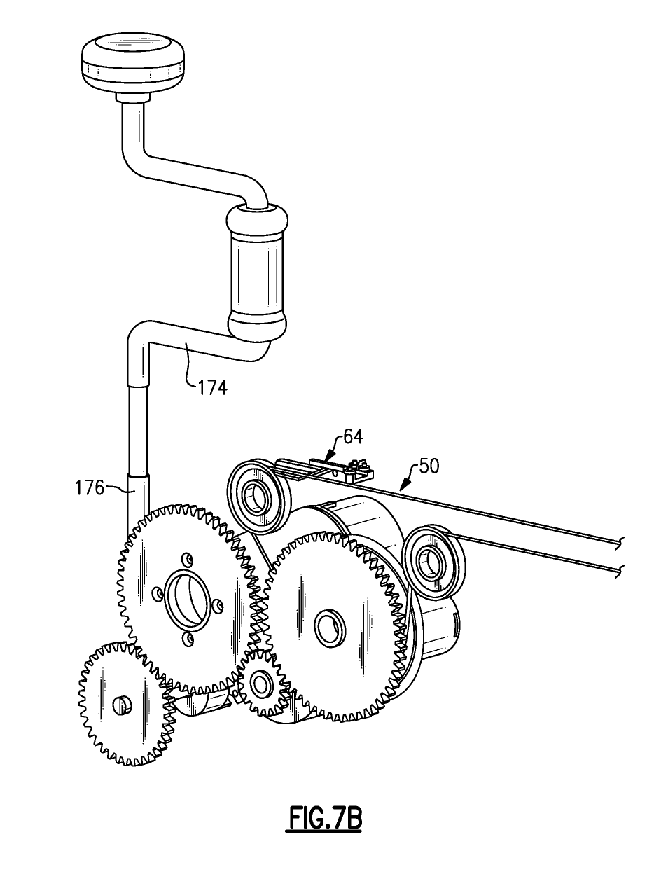

The cover system 20 also includes a manual override system (FIGS. 7A-9) that is used to extend or retract the tonneau cover if there is a loss of power or malfunction of the electric drive motor.

With continuing reference to FIG. 1, a frame 22 has laterally spaced apart guide rails 24, which may be provided by aluminum extrusions with various channels. A flexible cover 26, or soft tonneau cover, which may be constructed from typical soft tonneau cover materials, for example vinyl, is supported by and can slide within channels in the guide rails 24, which are secured to the lateral sides 14 of the truck bed 12. A drive system 28 slides the flexible cover 26 between the open and closed positions along a path provided by the guide rails 24.

Multiple bows 30, 32 are longitudinally spaced apart from one another and arranged beneath an underside of the flexible cover 26 to support, for example, aerodynamic loads and the weight of snow. The bow 32 is the last bow, which is arranged at a terminal end of the flexible cover 26 and nearest the gate 18. A seal 33 is mounted to the bow 32 and engages the gate 18 when the flexible cover 26 is in the closed position. In one example, the bows 30 curve upward toward an underside of the flexible cover 26 in the lateral direction to provide improved support. Various techniques can be used to maintain desired spacing between the bows 30, 32 when the flexible cover 26 is extended.

Referring to FIG. 1B, the drive system 28 includes a cassette housing (collectively referred to as “42”) that may be constructed from multiple components to facilitate assembly, for example, base and top portions 42a, 42b, trim piece 42c and end 132. In one example, the cassette housing 42 is mounted to a preformed pocket in the front wall 16 of the truck bed 12.

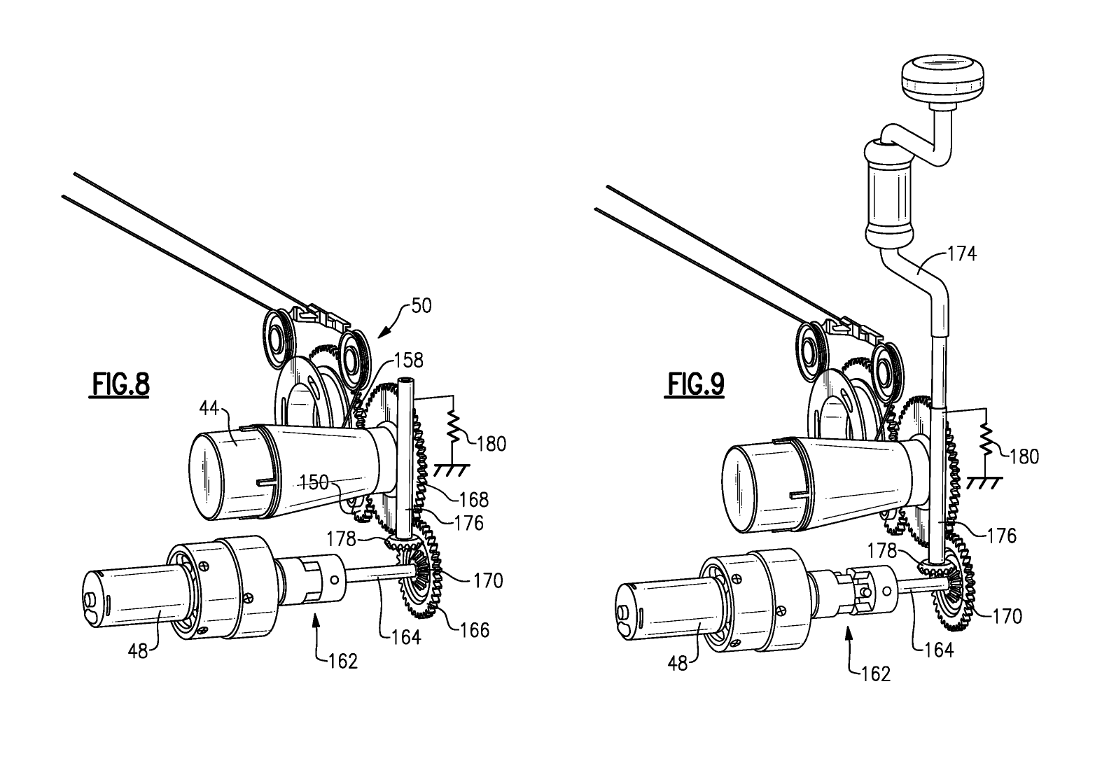

A main roller 44 (a portion of which is shown in FIG. 8) is driven by one or more motors 48 that rotationally drives the main roller 44, about which the flexible cover 26 is wrapped and unwrapped when opened and closed. In one example, the flexible cover 26 is secured to the main roller 44 by an “omega lock” configuration in which the flexible cover 26 is retained in a laterally extending slot by a cord. In one example, a motor (one shown) is housed beneath the main roller 44 at each of its opposing ends. The number, sizing and performance characteristics of the motors are selected based upon the application and requirements.

The bows 30, 32 are not wrapped about the main roller 44 with the flexible cover 26 when in the stowed position. Instead, the bows 30 are able to slide both with respect to the guide rails 24 and the flexible cover 26 since the bows 30 are not affixed to either the guide rails 24 or the flexible cover 26. In the stowed position, the bows 30, 32 are retained within the guide rails 24 and stored bunched together within the cassette housing 42. Thus, the drive system 28, including the flexible cover 26 and bows 30, 32, can be packaged in a very compact arrangement, occupying a minimal amount of space within the truck bed 12. Not wrapping the bows 30 about the main roller 44 also enables the use of laterally curved bows.

Referring to FIGS. 1A-1B, each guide rail 24 includes a structural section 34 and a cover section 36 secured to the structural section 34. Brackets (not shown) are secured to the side walls 14 of the truck bed 12 by fasteners.

In one example, a cover track is provided between the structural and cover sections 34, 36. Edges of the flexible cover 26 include longitudinally spaced retainers or buttons that are received within the track. The flexible cover 26 wraps about the main roller 44, as the flexible cover 26 is moved from the close position to the open position. An idler roller (not shown) extends laterally within the cassette housing 42 and is arranged approximately level with the guide rails 24 to maintain the edges of the flexible cover 26 in alignment with the track in the guide rails 24 as the flexible cover 26 is extended (closed) and retracted (opened). The bows 30, 32 may be supported by and slide relative to multiple, parallel bow tracks provided by each guide rail 24.

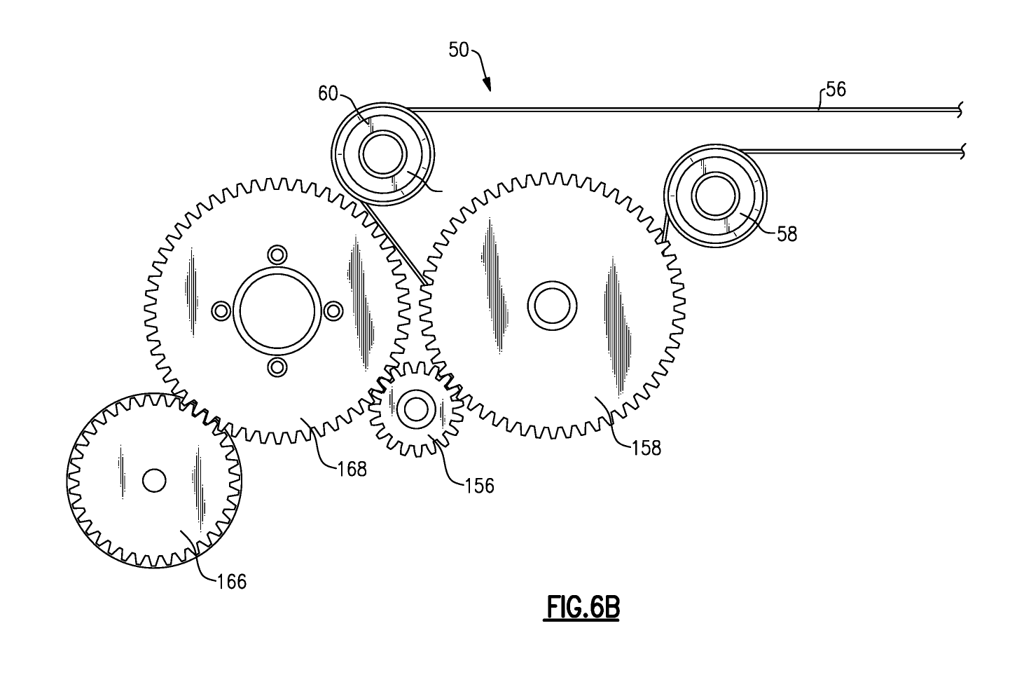

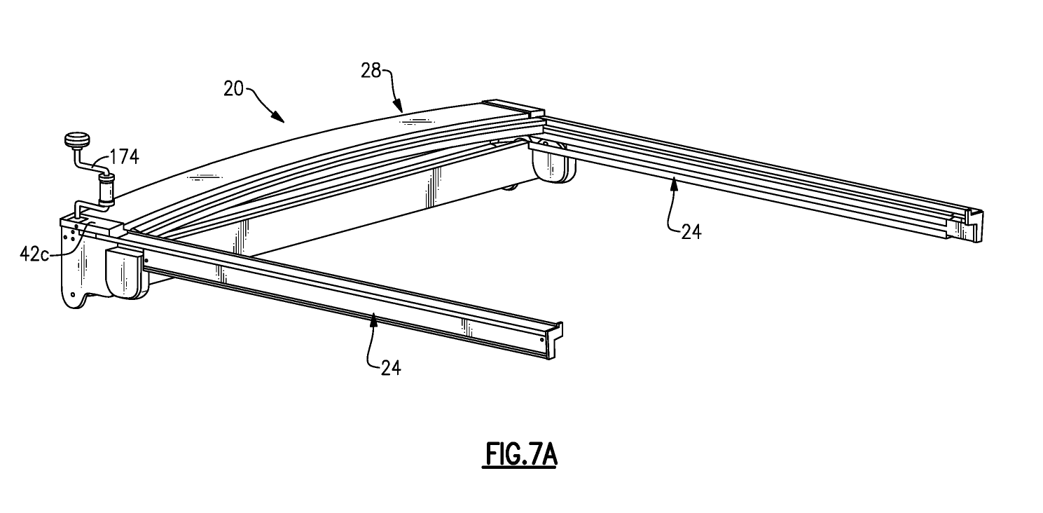

A cable system 50, shown in FIGS. 4, 6A and 6B, cooperates with the main roller 44 to retract and extend the flexible cover 26. The cable system 50 also coordinates movement of the bows 30, 32 with the flexible cover 26 while permitting the bows 30 to slide independently of the flexible cover 26 using, for example, a tether system.

With continuing reference to FIGS. 4 and 6A, the cable system 50 includes a cable drum 52 arranged at either side (one end shown) of the main roller 44 (FIG. 6A). A pulley (not shown) is arranged at a distal end of each guide rails 24 opposite the drive system 28. A cable 56, for example, a multi-strand steel cable, wraps about each cable drum 52 and pulley set. The cable drum 52 includes helical grooves, which prevents the cable 56 from wrapping about itself during operation which would cause undesired noise and wear. First and second idlers 58, 60 may be arranged to route the cables 56 from the cassette housing 42 to the guide rails 24. Since the routing and proper tensioning of the cable 56 is important, it is desirable to enable assembly and installation of cover system 20 into the vehicle in such a way that does not disturb the cable system 50.

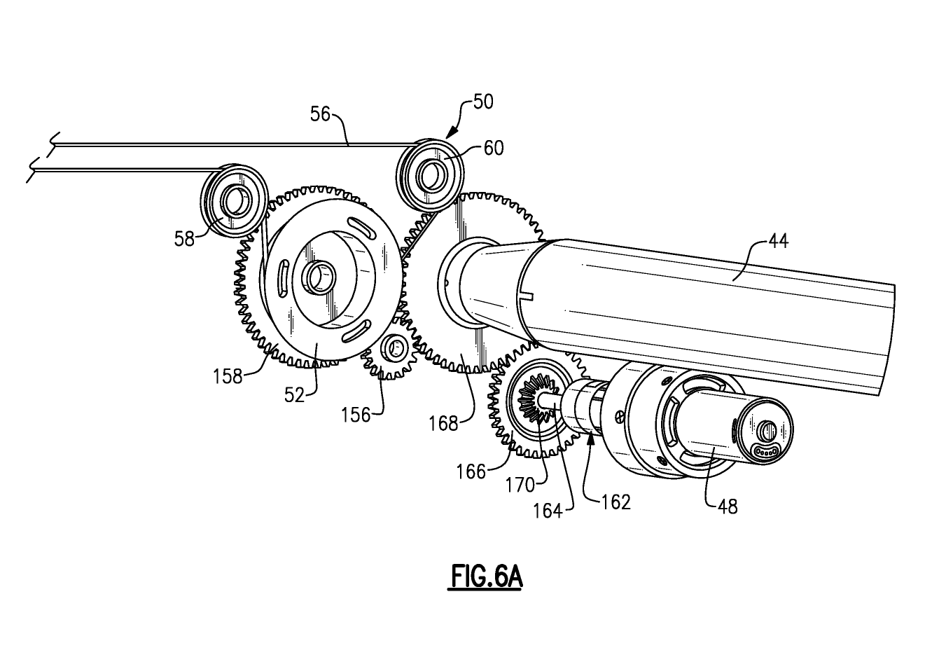

Referring to FIGS. 4 and 5, ends of the last bow 32, which is secured to the end of the flexible cover 26 must be attached to each cable 56 (one shown) such that the last bow 32 moves in tandem with the cable 56. In operation, with the flexible cover 26 in a retracted position, the motor 48 is driven to unwrap the flexible cover 26 from the main roller 44 and open the soft tonneau cover. The motor 48 rotationally drives the cable drum 52 (along with the main roller 44) to pull the last bow 32 and the flexible cover 26 via the cable system 50 toward the gate 18 to draw the soft tonneau cover taut.

As discussed previously, in order to install the disclosed cover system 20 in an aftermarket or production environment, it is desirable to package the guide rails 24 in a parallel arrangement with respect to drive system 28. However, one challenge is that the guide rails 24 house the cable system 50 which extends and retracts the bows supporting the flexible cover. Thus, drive must be transferred from the drive system 28 to the guide rails 24 during assembly by 1) coupling the motor 48 to the cable system 50, and 2) coupling the bow 32 to the cable 56.

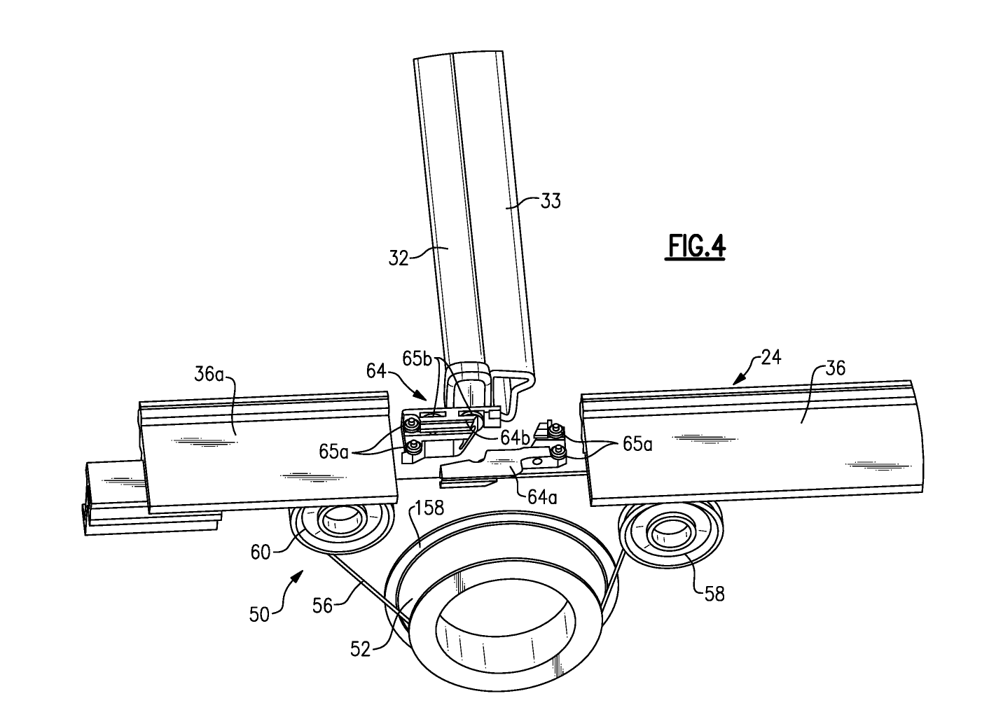

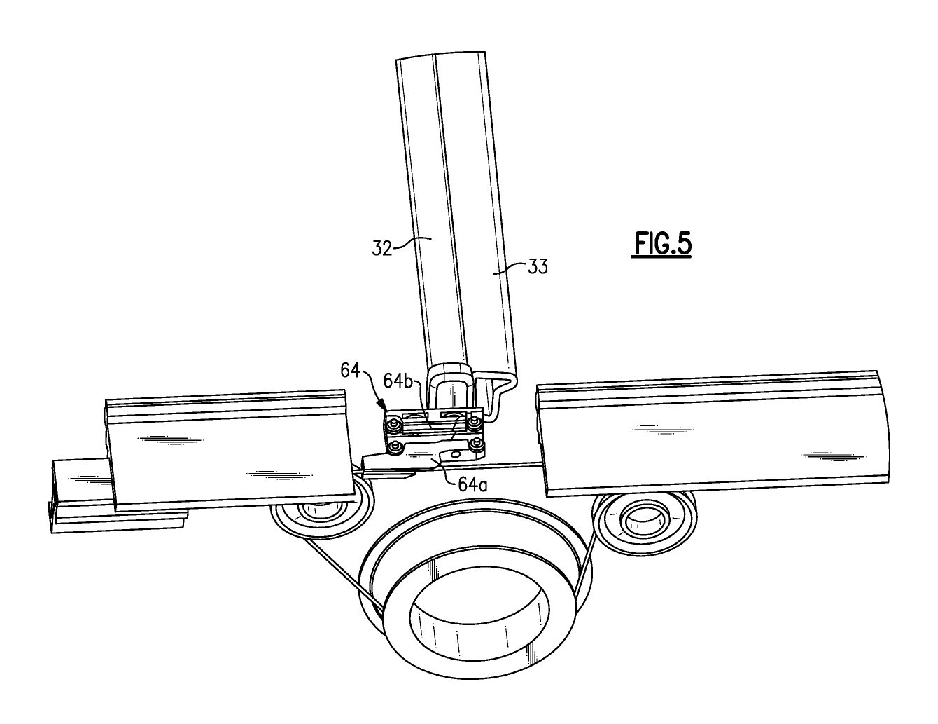

One example connection arrangement is illustrated in FIGS. 2A-3B. A joint 150 is provided between first and second members 152, 154 respectively provided by the drive system 28 and guide rail 24, which brings drive and driven gears 156, 158 (FIG. 1C) into meshing engagement with one another. The first and second members 152, 154 may be aluminum extruded elements that have internal channels or grooves. A connector 153, shown in FIG. 2C, may be received in the channels of both the first and second members 152, 154. A set screw 155 can be used (one shown) to secure the connector 153 to the first and second members 152, 154. Of course, other joint configurations can be used to easily connect the guide rails 24 to the drive system 28 during assembly and installation into the vehicle.

The flexible cover 26 and bows 30, 32 are carried by the pre-assembled drive system 28. Ultimately, the last bow 32 must be connected to the cable 56 carried by the guide rail 24, a portion of which is removed in FIG. 4 for clarity. A bow end 64 supports each of the opposing ends of the last bow 32 and connects the bow 32 to the cable 56. The bow end 64 includes a first portion 64a that is permanently secured to the cable 56 as part of the pre-assembled guide rail 24. A second portion 64b is connected to an end of the last bow 32, as shown in FIG. 5, and is part of the pre-assembled drive system 28. The assembled bow end 64 carries horizontal and vertical rollers 65a, 65b that are received within the channel provided by the guide rail 24. During assembly, the flexible cover 26 is pulled from the main roller 44, and the first and second portions 64a, 64b are secured to one another.

Referring to FIGS. 6A and 6B, the motor 48 is connected to a first gear 166 that is driven by a shaft 164 through a clutch 162. The first gear 166 meshes with a second gear 168 coupled to the drive gear 156. This gear assembly is housed within the drive system 28. The driven gear 158 is rotationally fixed to the cable drum 52 and arranged within a housing 160 supported by the guide rail 24. It should be understood that different gear configurations can be used. For example, gear 156 can be eliminated so that gears 158, 168 mesh directly with one another. With the drive system 28 assembled to the guide rails 24, the drive gear 156 and driven gear 158 are interconnected to one another. This gear set allows a smaller motor 48 to be used since these gears provide a reduction, but a relatively high speed motor may be desired to provide more rapid opening and closing of the tonneau cover.

As is shown in FIG. 6A, a first bevel gear 170 is rotationally fixed to the shaft 164. In the case of a malfunction or power loss to the motor 148, the flexible cover 26 can be manually opened and closed by a hand crank 174, which can be inserted through an opening in the drive system 28 once the access cover 172 (FIG. 1B) has been removed.

Referring to FIGS. 8 and 9, a second bevel gear 178 is affixed to one end of a tube 176 that is biased by a spring 180 to a retracted position in which the first and second bevel gears 170, 178 are not engaged with one another (FIG. 8). When a user wishes to manually operate the flexible cover 26, an end of the crank 174 is inserted into the tube 176 to rotationally affix the crank 174 and tube 176 to one another, for example, by a splined engagement. The tube 176 is depressed as the crank 174 is inserted, overcoming the spring 180 and allowing the second bevel gear 178 to engage the first bevel gear 170 (FIG. 9). With the clutch 162 uncoupled, the crank 174 can be rotated to drive the cable system 50 via the gear set.

Another cover system 120 is shown in FIG. 10. Rather than having removable guide rails 24, the guide rails 124 are pivotally attached to the drive system 128 by first and second pivot joints 190, 192. The first and second pivot joints 190, 192 are provided at unequal first and second distances 194, 196, respectively. This enables the guide rails 124 to be folded inward, as indicated by the dashed lines, in a manner that does not interfere with one another.

In operation, the motor 48 communicates with a controller that receives commands from an input, such as a two-way switch, to open and close the soft tonneau cover. The controller can provide a variety of functionality, for example, the controller may be configured to detect an obstruction to the flexible cover 26 within the truck bed 12. The controller commands the motor 48 to open the flexible cover 26 in response to detecting the obstruction. In another example, the controller may be programmed to open/close the flexible cover 26 to a predetermined position.

It may become necessary or desirable to operate the electric tonneau cover without use of the motor 48. Thus, the motor 48 may include a clutch 162 actuatable by an override device to release the main roller 44 from the motor 48.

A latching mechanism is used to lock the flexible cover 26 when fully closed/extended. Each guide rail 24 includes a latch that selectively cooperates with a stop associated with the bow 32, for example. The soft tonneau cover will latch/lock when the flexible cover 26 is fully extended/closed. The motor 48 then rotates the main roller 44 slightly as if the flexible cover 26 is being retracted. However, since the last bow 32 is maintained in its position near the tailgate, the flexible cover 26 is pulled taut. In this manner, the flexible over 26 is tensioned and prepared for vehicle travel to better withstand aerodynamic loads. When a user wishes to open the cover 26, a command from the controller is sent to an actuator that first releases the latch, and then the flexible cover 26 can retract/open.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A retractable cover system comprising:
a pre-assembled drive system including:
a main roller about which a flexible cover is wrapped;
bows supporting the flexible cover in an extended position, the bows include a last bow; and
a drive motor operatively coupled to the main roller and configured to move the flexible cover between the extended position and a retracted position;
a pre-assembled guide rail including:
a cable system having a driven gear operatively coupled to a drum; and
a cable wrapped about the drum and at least one idler, the last bow unsecured to the cable of the pre-assembled guide rail;
a joint configured to interconnects the pre-assembled guide rail to the pre-assembled drive system in an assembled condition to provide an assembled retractable cover system, the joint permits the drive gear and the driven gear to engage one another in the assembled condition; and
wherein the last bow is secured to the cable in the assembled condition.

2. The retractable cover system according to claim 1, wherein the joint is a pivot joint that connects the pre-assembled guide rail to the pre-assembled drive system.

3. The retractable cover system according to claim 2, wherein the joint is a first joint, and the guide rail is a first guide rail, and comprising a second joint supporting a second guide rail to the pre-assembled drive system on an opposite lateral side than the first guide rail, the first and second joints offset from one another to permit the first and second guide rails to fold inward toward and parallel to one another in a shipping condition.

4. The retractable cover system according to claim 1, wherein the joint is a provided by at least one of a detachable tongue and groove arrangement or a lap joint arrangement that permits the pre-assembled guide rail to be fully decoupled from the pre-assembled drive system in a shipping condition.

5. The retractable cover system according to claim 1, wherein the drum and the driven gear are coaxial with and rotationally fixed relative to one another.

6. A method of assembling a retractable cover system comprising the steps of:
providing a pre-assembled guide rail with a cable system;
providing a pre-assembled drive system including a flexible cover wrapped about a main roller operatively coupled to a motor; and
connecting the pre-assembled drive system to the pre-assembled guide rail and operatively coupling the motor to the cable system.

7. The method according to claim 6, wherein the cable system includes a cable wrapped about a drum and at least one idler, the connecting step includes operatively coupling the motor to the drum.

8. The method according to claim 7, wherein the pre-assembled guide rail includes a driven gear operatively coupled to the drum, and the pre-assembled drive system includes a drive gear operatively coupled to the motor, wherein the connecting step includes moving the drive gear and the driven gear into meshing engagement with one another.

9. The method according to claim 8, wherein the drum and the driven gear are coaxial with and rotationally fixed relative to one another.

10. The method according to claim 8, wherein the connecting step includes unfolding the pre-assembled guide rail relative to the pre-assembled drive system about a pivot joint.

11. The method according to claim 8, wherein the connecting step includes securing an end of the pre-assembled guide rail to the pre-assembled drive system.

12. The method according to claim 7, wherein the pre-assembled drive system includes bows supporting the flexible cover and including a last bow, and the connecting step includes securing the last bow to the cable.

13. A retractable cover system comprising:
a drive system having a flexible cover wrapped about a main roller, a motor is operatively coupled to the main roller and is configured to move the flexible cover between an extended position and a retracted position; and
a crank configured to selectively and operatively cooperate with the main roller to manually move the flexible cover between an extended position and a retracted position without power from the motor.

14. The retractable cover system according to claim 13, comprising a first bevel gear operatively coupled to the main roller, and a second bevel gear configured to selectively mesh with the first bevel gear in response to a crank.

15. The retractable cover system according to claim 14, comprising a spring biasing the second bevel gear to a normally unmeshed position with respect to the first bevel gear.

16. The retractable cover system according to claim 15, wherein the second bevel gear is supported by a tube, the crank configured to be inserted into the tube to rotationally fix the crank relative to the tube, wherein the tube is configured to move the second bevel gear into engagement with the first bevel gear in response to axial movement of the crank.

17. The retractable cover system according to claim 16, wherein an access cover removably secured to the drive system covers the tube.

18. The retractable cover system according to claim 13, comprising a guide rail has a cable system with a cable wrapped about a drum and at least one idler, the drum operatively coupled to the motor, the drive system includes bows configured to support the flexible cover when in the extended position.

19. A method of manually operating a retractable cover system comprising the steps of:
inserting a crank into a drive system having a flexible cover wrapped about a main roller;
rotationally driving the main roller with the crank; and
moving a flexible cover along guide rails between an extended position and a retracted position in response to the rotationally driving step.

20. The method according to claim 19, wherein the inserting step includes moving first and second bevel gears into engagement with one another.

21. The method according to claim 20, wherein the inserting step includes depressing a spring that biases the first and second bevel gears apart from one another.

22. The method according to claim 20, wherein the rotationally driving step includes rotationally driving the second bevel gear with the first bevel gear.

23. The method according to claim 19, comprising the step of decoupling a clutch that interconnects a motor to the main roller.
